(19) United States
(12) Patent Application Publication
(10) Pub. No.: US 2026/0169968 A1
(43) Pub. Date: Jun. 18, 2026

(54) BINARY QUANTIZATION OF VECTOR EMBEDDINGS IN A DATA MANAGEMENT SYSTEM

(71) Applicant: Elastic Technologies (US) Inc., San Francisco, CA (US)

(72) Inventors: Benjamin Whitefield Trent, Greer, SC (US); Thomas James Veasey, York (GB); John Wagster, Franklin, TN (US)

(21) Appl. No.: 19/418,560

(22) Filed: Dec. 12, 2025

Related U.S. Application Data
(60) Provisional application No. 63/733,179, filed on Dec. 12, 2024.

(51) Int. Cl. G06F 16/22; G06F 16/2457

(52) U.S. Cl. CPC G06F 16/2237; G06F 16/24573

(57) ABSTRACT

According to an aspect, a method includes computing a representative point for at least a plurality of data vectors representing data to be added to a vector index, generating an adjusted data vector by adjusting a data vector of the plurality of data vectors around the representative point, and generating a bit vector using the adjusted data vector, including determining a quantization interval that reduces a quantization error in a similarity computation, and mapping values of the adjusted data vector to components of the bit vector using the quantization interval.

### CROSS-REFERENCE TO RELATED APPLICATION

This application claims the benefit of and priority to U.S. Provisional Application No. 63/733,179, filed Dec. 12, 2024, which is incorporated by reference herein in its entirety.

### BACKGROUND

A vector index may be used to store vector representations of data, and the vector index is used to search against submitted queries. In conventional systems, vector indexes often store vectors as floating-point values (e.g., 32-bit or 16-bit precision). Storing and retrieving these high-precision vectors may use substantial memory bandwidth and storage capacity, and the cost of performing similarity computations scales with vector dimensionality and/or index size. As the vector index becomes larger in size, memory pressure increases, cache locality decreases, and/or query throughput may become constrained due to the amount of data to be scanned or transferred during search operations.

While quantization techniques reduce vector storage size, applying a uniform low-precision quantization to vectors may remove magnitude information that may be useful for distinguishing closely related embeddings, which can affect ranking accuracy during retrieval. In some conventional systems, the same quantization strategy is applied to both stored vectors and query vectors, so the system may lack sufficient resolution to reconstruct relative distances when scoring search results. As index size increases, these effects compound: the number of compressed vectors grows, the amount of information preserved per vector decreases, and/or the similarity comparison performed during search may have reduced fidelity due to limited representational precision.

### SUMMARY

This disclosure relates to efficiently indexing and searching high-dimensional data, such as product catalog embeddings, user profile vectors, or document summaries, by transforming them into highly compact, storage-optimized representations. A sequence of operations may involve ingesting a plurality of data vectors and applying a preconditioning matrix to perform an orthogonal transformation that is configured to make vector components approximately normally distributed. This step may help the data conform to assumptions made for the subsequent quantization method.

The vectors are adjusted around a representative point (e.g., a centroid) to create adjusted data vectors. The technique involves the generation of the bit vectors: for each (or some other subset of) individual adjusted data vector, a binary quantization engine determines a specific quantization interval by performing an optimization. This unique per-vector optimization may reduce (e.g., minimize or satisfy a threshold) the quantization error in a similarity computation by comparing the adjusted vector against a neighboring vector to calculate the best magnitude scaling for the compressed representation.

The resulting bit vectors and corresponding error correction metadata (which preserves lost magnitude information when converting to quantized form and the information lost when centering) are then stored in an index segment. During a search operation such as matching a user's query vector (e.g., an encoded search for “blue running shoes”) against millions of product embeddings, the process may utilize asymmetric quantization to help maintain high ranking fidelity while the index remains maximally compressed. The query vector is adjusted around a second representative point and encoded using a higher-precision multi-bit quantization (e.g., int4) to create a quantized query vector. This multi-bit vector is then subjected to a bit-slicing process that generates translated query components, aligning the data for hardware-accelerated comparison via single instruction, multiple data (SIMD) instructions.

The similarity score between the high-precision quantized query vector and the low-precision stored bit vectors is estimated using a functional decomposition of the dot product. This decomposition may include a query correction term, a data correction term, and a quantized residual term, collectively helping the score accurately reflect the original floating-point similarity.

The overall design may promote efficiency and scalability through its underlying structure. In some examples, the vector index is structured into vector clusters managed by hierarchical centroids. This allows the search engine to employ a load-on-demand mechanism, where the cluster partitions (e.g., product categories determined to be relevant by the coarse search against centroids) are loaded from disk at execution time. This approach may reduce memory footprint and enable efficient similarity search across large datasets that may otherwise exceed the capacity of random access memory (RAM) based vector systems. This combination of per-vector optimized compression, multi-bit asymmetric search, and/or clustered structure provides high-recall results with low latency for applications like real-time product recommendations and massive-scale semantic search.

In some aspects, the techniques described herein relate to a method including: computing a representative point for at least a plurality of data vectors representing data to be added to a vector index; generating an adjusted data vector by adjusting a data vector of the plurality of data vectors around the representative point; and generating a bit vector using the adjusted data vector, including: determining a quantization interval that reduces (e.g., minimizes) a quantization error (or the quantization error satisfies a minimum condition) in a similarity computation; and mapping values of the adjusted data vector to components of the bit vector using the quantization interval.

In some aspects, the techniques described herein relate to an apparatus including: a database storing a vector index; and an index engine including executable instructions that cause at least one processor to: compute a representative point for at least a plurality of data vectors representing data to be added to the vector index; generate an adjusted data vector by adjusting a data vector of the plurality of data vectors around the representative point; and generate a bit vector using the adjusted data vector, including: determine a quantization interval that reduces a quantization error in a similarity computation; and map values of the adjusted data vector to components of the bit vector using the quantization interval.

In some aspects, the techniques described herein relate to a non-transitory computer readable medium storing executable instructions that cause at least one processor to execute operations, the operations including: computing a representative point for at least a plurality of data vectors representing data to be added to a vector index; generating an adjusted data vector by adjusting a data vector of the plurality of data vectors around the representative point; and generating a bit vector using the adjusted data vector, including: determining a quantization interval that reduces a quantization error in a similarity computation; and mapping values of the adjusted data vector to components of the bit vector using the quantization interval.

### BRIEF DESCRIPTION OF THE DRAWINGS

FIG. 1A illustrates a system for binary vector quantization for converting multi-dimensional data vectors into binary vectors according to an aspect.

FIG. 1B illustrates an example of an index segment having bit vectors and error correction metadata according to an aspect.

FIG. 1C illustrates an example of an index engine configured to generate bit vectors from multi-dimensional data vectors according to an aspect.

FIG. 2 illustrates an example of an index segment with a plurality of bit vectors and error correction metadata according to an aspect.

FIG. 3 illustrates a quantization process of generating bit vectors according to an aspect.

FIG. 4A illustrates an example of a merging engine configured to generate a merged index segment by merging a first index segment and a second index segment according to an aspect.

FIG. 4B illustrates an example of a merged index segment according to an aspect.

FIG. 5A illustrates an example of a binary quantization engine configured to generate a quantized query vector from a multi-dimensional query vector according to an aspect.

FIG. 5B illustrates a quantization process of generating a quantized query vector according to an aspect.

FIG. 6 illustrates a technique of partitioning a vector index into vector clusters and storing the clustered vectors as bit-encoded representations that can be loaded on-demand during query execution according to an aspect.

FIG. 7 illustrates a flowchart depicting example operations of binary vector quantization for converting multi-dimensional data vectors into binary vectors according to an aspect.

### DETAILED DESCRIPTION

This disclosure relates to an effective approach to processing and searching high-dimensional vector data, which differentiates it from previous techniques relying on generic transformations. The technical problem addressed by this approach stems from the challenges of scaling vector search systems. For example, storing and retrieving high-precision floating-point vectors may require substantial memory bandwidth and storage capacity, and the cost of performing similarity computations scales unfavorably with vector dimensionality and index size.

Some conventional quantization methods may reduce storage but often introduce significant error, which may affect ranking accuracy. The technical solution involves a multi-stage indexing and search process optimized for fidelity and/or speed. To prepare the data, an orthogonal transformation is applied using a preconditioning matrix configured to decorrelate components of the data vectors. This may help make vector components approximately normally distributed required for the subsequent quantization method. In some examples, a binary quantization engine generates the bit vectors by determining a specific quantization interval for each vector (or a subset of vectors). This interval may be calculated by comparing the adjusted data vector against a neighboring vector to reduce (e.g., minimize) the quantization error in a similarity computation. For search, the examples discussed here may use asymmetric quantization. While stored vectors are low-precision, the incoming query vector is adjusted around a second representative point and encoded with a higher-precision multi-bit quantization to create a quantized query vector. The similarity score is then estimated using a decomposition of the dot product that incorporates one or more scalar components such as a query correction term, a document correction term, and the quantized residual term.

In some examples, the optimization process is performed to determine the quantization interval such that the resulting quantization error satisfies a threshold (e.g., a predetermined fidelity threshold). The threshold may correspond to a minimum acceptable reconstruction accuracy for the similarity score. For instance, the binary quantization engine may be configured to select the quantization boundary parameters produce a quantization error below a specific maximum tolerance level. This approach ensures that the compressed bit vector preserves sufficient magnitude information to maintain high ranking accuracy during the subsequent search operation.

The dot-product specific quantization may preserve the similarity (e.g., required similarity) information despite encoding the index vectors using minimal bits, resulting in high fidelity with a high level of compression. The asymmetric quantization and scoring decomposition may reduce the computational bottleneck during search. In some examples, the technology may also be designed to enable hardware-accelerated comparison using SIMD instructions. In some examples, the vector index is structured into vector clusters managed by hierarchical centroids, allowing the search engine to employ a load-on-demand mechanism. This approach may reduce memory footprint and enable efficient similarity search across large, disk-resident datasets

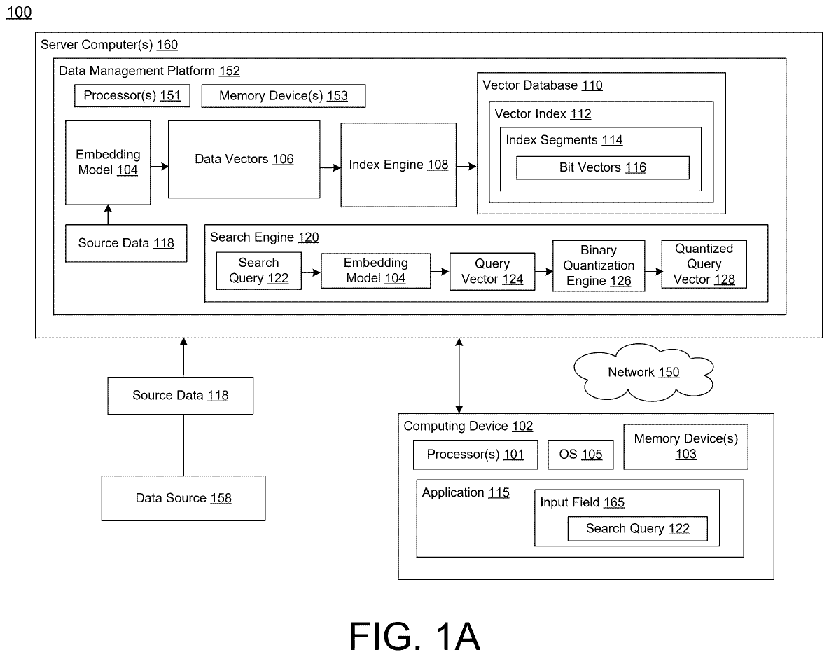

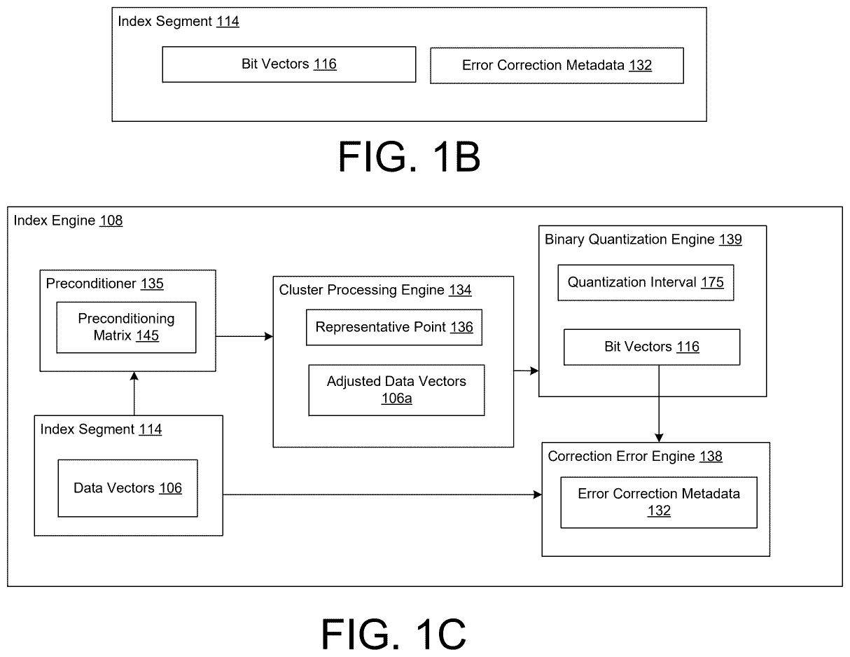

FIGS. 1A to 1C illustrate a system 100 for binary vector quantization for converting multi-dimensional data vectors 106 into bit vectors 116 according to an aspect.

The system 100 may be a data management system. The system 100 may ingest, store, and search data imported from one or more data sources 158. The system 100 includes a data management platform 152 executable by one or more server computers 160. The data management platform 152 may receive source data 118 from one or more data sources 158.

A data source 158 is a component in a computing system. A data source 158 may be an end point (e.g., a user device such as workstation, smartphone, laptop, or wearable device, etc.), a network device (e.g., router, switch, or firewall), a server (e.g., an application server, a database server, or a web server), or an application (e.g., email server, a cloud service, a server application, or a client application). The data source 158 may receive or generate source data 118 that is transmitted, over a network 150, to the data management platform 152. In some examples, the source data 118 includes textual data, audio data, and/or video data.

In some examples, the source data 118 can be referred to as documents. The source data 118 may include private documents, e.g., documents that are accessible by authorized users of the system 100. The source data 118 may include public documents, e.g., documents that are accessible by the general public. The source data 118 may include private and public documents. In some examples, the source data 118 are organizational documents of an organization associated with the system 100. In some examples, the source data 118 includes security-related data about system activity, network traffic, and/or security events. The source data 118 may include event data about security events about the data source(s) 158.

The data management platform 152 includes an embedding model 104 configured to generate data vectors 106 from source data 118. The embedding model 104 may be a software component, machine-learning model, or feature-extraction model that converts input data (e.g., the source data 118) into data vectors 106 (e.g., numeric values). In some examples, the embedding model 104 is a neural-network-based encoder. In some examples, the embedding model 104 is a statistical or rule-based transformation model.

The output of the embedding model 104 includes data vectors 106. The data vector 106 may represent an entire document, web page, paragraph, or user review. The data vector 106 may encode the document's content, context, and semantic meaning, enabling semantic search and question-answering systems. The data vectors 106 may be multi-dimensional vectors that may include floating point values such as 32-bit values (e.g., float32) or 16-bit values (e.g., float16, bfloat16). In some examples, floating point values include smaller or larger precision formats depending on the representation requirements of the embedding model. A data vector may be a structured numeric representation of input data. A data vector 106 may also be referred to as a feature vector, an embedding vector, or a multi-dimensional vector. In some examples, a data vector 106 is referred to as a document embedding or a document vector. In some examples, a data vector 106 includes a set of numeric components that each represent characteristics or learned features of the source data 118. In some examples, a data vector 106 includes values that encode semantic, visual, or contextual relationships present in the source data 118.

The data management platform 152 includes an index engine 108 configured to generate or update a vector index 112 using the data vectors 106. The index engine 108 refers to a software component, indexing module, or vector-processing subsystem that receives data vectors 106 and transforms the data vectors 106 into index-storable representations. In some examples, the index engine 108 is a pipeline of software instructions that perform vector re-centering, vector quantization, and/or storage operations. In some examples, the index engine 108 is implemented as one or more executable processes hosted on the server computer(s) 160. The index engine 108 transforms the data vectors 106 into index-storable representations, generating bit vectors 116, which are stored in an index segment 114 of a vector index 112.

The vector index 112 is storable in a vector database 110, which may function as a persistent storage structure, an index repository, or a database configured to store multiple index segments 114. The vector database 110 may be an example of a memory device 153, a storage volume, or a structured data store that retains vectors and their derived representations. In some examples, the vector database 110 stores compressed or quantized representations such as bit vectors 116 in a storage format.

The vector index 112 includes index segments 114. An index segment 114 refers to a subset, grouping, or partition of vectors within the vector index 112. An index segment 114 may store vectors that were ingested within a similar time window, vectors assigned to a common storage partition, or vectors grouped for update operations. In some examples, index segments 114 enable incremental write, update, and/or merge operations. In some examples, the vector index 112 includes multiple index segments 114 to allow efficient search, incremental indexing, or partial rebuilding of index content.

The index engine 108 is configured to receive at least one data vector 106, generate one or more bit vectors 116, and store the bit vectors 116 in an index segment 114. A bit vector 116 refers to a vector representation encoded using one or more bits per dimension and may also be referred to as a binary vector, compressed vector, or quantized embedding representation. The bit vectors 116 may represent component sign values, threshold-based encodings, or binary quantization outputs derived from the data vectors 106. In some examples, the index engine 108 stores bit vectors 116 as one-bit-per-dimension encodings. In some examples, the bit vectors 116 include multi-bit encodings (e.g., two-bit or four-bit values). The index engine 108 may add the index segment 114 to the vector index 112 when the segment is generated, updated, or merged.

In some examples, the vector index 112 is implemented as a hierarchical navigable small world (HNSW) graph structure. In some examples, the vector index 112 is a multi-layer graph arrangement in which vectors are stored as nodes connected by proximity-based edges. In some examples, the HNSW graph includes multiple layers of connectivity, where upper layers represent coarse similarity connections and lower layers provide denser local connections for fine-grained retrieval. An HNSW implementation of the vector index 112 may allow a search operation to traverse the graph by progressively navigating through vector neighborhoods until candidate vectors are identified.

In some examples, the vector index 112 includes hierarchical cluster partitions. A hierarchical cluster partition refers to a multi-level vector grouping, cluster tree, or centroid-tree structure in which vectors are arranged in layers of clusters according to similarity. In some examples, a cluster is associated with a cluster-representative point, feature anchor, or cluster centroid, and child clusters provide increased resolution or finer similarity boundaries. In some examples, hierarchical cluster partitions allow the index engine 108 to evaluate selected (e.g., only selected) partitions during search, rather than accessing vectors (e.g., all vectors) stored in the vector index 112.

As shown in FIG. 1C, the index engine 108 may receive one or more data vectors 106 until the data vectors 106 satisfy an index segment 114. For example, the index engine 108 may receive one or more data vectors 106 over time until a collection of received data vectors 106 fills or satisfies a threshold for an index segment 114 (e.g., when enough data vectors 106 have been buffered or when a flush condition triggers).

The index engine 108 includes a preconditioner 135. The preconditioner 135 is configured to apply an orthogonal transformation to the data vectors 106 as a preconditioning step. The preconditioning transformation may be used to make the vector component distributions of the data vector 106 more normally distributed, which may improve the robustness of the quantization process for pathological vector distributions. This preconditioning step may be performed prior to the generation of adjusted data vectors 106a.

The preconditioner 135 applies an orthogonal transformation to a data vector 106. An orthogonal transformation corresponds to a change of basis that is desirable because it does not change a similarity metric (e.g., dot product, cosine similarity, or Euclidean distance). Applying an orthogonal transformation may include multiplying the data vector 106 by a preconditioning matrix 145. The preconditioning matrix 145 is an orthogonal matrix. An orthogonal matrix is a square matrix whose columns and rows are orthonormal unit vectors (e.g., the transpose of the matrix is equal to its inverse). Applying the preconditioning matrix 145 to a data vector 106 generates a transformed data vector. The resulting component distribution of the transformed vector becomes more normally distributed, which may be a consequence of the central limit theorem. This normality may be beneficial because the initialization procedure of the quantization assumes that the components are normally distributed.

The preconditioner 135 is configured to apply an orthogonal transformation to the plurality of data vectors 106 using a preconditioning matrix 145, where the preconditioning matrix 145 is configured to transform the components of the plurality of vectors 106 to be individually normally and distributed (e.g., identically distributed). The components that are approximately normally and distributed (e.g., identically distributed) are the individual dimensional values (e.g., the floating point values) that form a data vector 106. The orthogonal transformation applies a unified rotation and reflection to the vector space, transforming the input data into a new coordinate system where the resulting components are sums of original components so the central limit theorem applies to their distribution. This step is performed because the subsequent binary quantization engine 139 (which uses the component-wise threshold rule) operates accurately (e.g., most accurately) under the assumption that the input component values are normally and distributed (e.g., identically distributed). By making the components approximately normally distributed and distributed (e.g., identically distributed), the preconditioner 135 may ensure that the data conforms better to the distribution assumptions for (e.g., required for) binary quantization.

Individually normally distributed may mean that the component values across the dataset follow a normal distribution, which is a distribution assumption needed for the subsequent quantization process. Distributed (e.g., identically distributed) may mean that the statistical properties (e.g., mean and variance) of components (e.g., all components) are substantially the same, allowing the same quantization threshold to be optimally applied across dimensions. The transformation is structural, applying a unified rotation to the vector space, transforming the input data into a new coordinate system where the resulting components exhibit minimal statistical correlation and suitable marginal distributions.

The preconditioning matrix 145 includes floating point values (e.g., d², where d is the vector dimension). Applying the transformation to the data vectors 106 may require a plurality of floating point multiplications (e.g., nd² floating point multiplications where n is the number of documents (e.g., data vectors 106)). A dense preconditioner for vectors with 1024 dimensions may request 4 MB storage per matrix and may perform more than one million multiplications per document (e.g., per data vector 106) added to the vector index 112.

The preconditioner 135 may use a sparse block diagonal matrix as the preconditioning matrix 145, which may overcome the computational cost of a dense orthogonal matrix. A sparse orthogonal matrix is an orthogonal matrix where the majority of elements are zero, which may result in a significantly lower memory and computational cost. The sparse orthogonal matrix may be block-diagonal, e.g., non-zero values are confined to sub-matrices (blocks) along the main diagonal. This architecture may ensure that a few components are mixed, which may be sufficient for high-dimensional vectors.

In some examples, the preconditioner 135 applies the sparse block diagonal matrix to a data vector 106 by assigning vector components to blocks (e.g., the sub-matrices that form the sparse block diagonal matrix). A block (e.g., each block) dictates which subset of the original vector components will be mixed together during the orthogonal transformation. In some examples, the preconditioner 135 applies the sparse block diagonal matrix to the blocks in a way that balances variance, thereby ensuring that the vector components mixed within a single block have homogeneous statistical properties. In some other examples, the preconditioner may choose components to mix in a single block at random.

The preconditioner 135 may execute an algorithm (e.g., a greedy algorithm) to apply the sparse block diagonal matrix. For example, the preconditioner 135 may initialize a variance sum (v) to zero for each block (j) and set the block assignment set (bⱼ) to empty. The preconditioner 135 may iterate through the vector component indices (i) in descending order of their component variance. For the component currently under consideration, the preconditioner 135 selects the block (j) that currently holds the minimum accumulated variance (vₖ):j←arg minₖ vₖ. Once the block (j) is selected, the preconditioner 135 assigns the current component (i) to that selected block (j) (e.g., add i to bⱼ). The preconditioner 135 then checks if the size of the block (|bⱼ|) is less than the maximum dimension size for that block (d). If the size limit is not yet reached, the preconditioner 135 adds the variance of the i^{th} component to the block's accumulated variance (vi). However, if the block has reached its dimension size, the preconditioner 135 sets the accumulated variance (vi) to infinity to minimize (e.g., prevent) subsequent components from being assigned to that block in the future. By executing this algorithm, the preconditioner 135 effectively balances the variance across the blocks, which may result in an optimized block diagonal preconditioning that achieves robust quantization quality similar to a computationally expensive dense transformation, but with lower (e.g., significantly lower) memory and indexing overhead.

The index engine 108 includes a cluster processing engine 134 configured to compute a representative point 136 using the group of data vectors 106 that form an index segment 114. In some examples, the cluster processing engine 134 receives the output of the preconditioner 135, e.g., the transformed data vectors 106. The representative point 136 may be a single point in vector space that represents the set of data vectors 106 to be stored in the index segment 114. In some examples, the representative point 136 is a centroid, e.g., the center of a group of data vectors 106. In some examples, the cluster processing engine 134 computes the representative point 136 by averaging corresponding component values across the data vectors 106. In some examples, the cluster processing engine 134 computes the representative point 136 using a weighted average of the component values of the data vectors 106.

The cluster processing engine 134 generates adjusted data vectors 106a by adjusting the data vectors 106 relative to the cluster representative point 136. Adjusting the data vectors 106 relative to the representative point 136 may include centering the data vectors 106 around the computed centroid. In some examples, the adjusted data vectors 106a are computed by subtracting a component (e.g., each component) of the representative point 136 from a component (e.g., each component) of the corresponding data vector 106. In some examples, the adjusted data vectors 106a maintain the same dimensionality as the data vectors 106 but are positioned around the representative point 136 to enable subsequent quantization into bit vectors 116.

The index engine 108 includes a binary quantization engine 139. The binary quantization engine 139 is configured to generate bit vectors 116 using a quantization process on the adjusted data vectors 106a. In some examples, the binary quantization engine 139 encodes each dimension of the adjusted data vectors 106a as one bit, and the resulting bit vectors 116 include a sequence of binary values that correspond to the dimensional components of the adjusted data vectors 106a. In some examples, the binary quantization engine 139 packs the binary values into a byte-aligned format to reduce storage space, improve memory alignment, and/or increase SIMD-based comparison throughput during search operations. In some examples, the binary quantization engine 139 produces a fixed-length bit vector 116 for adjusted data vector 106a, where a bit vector 116 is substantially smaller in memory footprint than the corresponding original data vector 106. In some examples, the quantization process of the binary quantization engine 139 is referred to as a first quantization process, which is further described as follows.

The binary quantization engine 139 may compute (e.g., directly compute) a quantization interval 175 to use when mapping the values (e.g., the floating-point component values) of the adjusted data vectors 106a to the bit vectors 116. The component floating-point values are mapped to quantized values based on q=a +kᵢ×(b−a), where [a, b] is the quantization interval 175 and kᵢ are the components of the resulting bit vector 116. The quantization interval 175 may represent a range of values (e.g., a continuous range of values) that is mapped to a discrete, quantized representation by snapping to the closest endpoint a or b. The term snapping may refer to an operation of assigning a continuous floating-point value to the nearest discrete boundary or level within the defined quantization interval 175. In some examples, the quantization interval 175 is defined by interval parameters such as a first boundary parameter a and a second boundary parameter b. In some examples, the interval parameters can be characterized as magnitude scale factors. In some examples, the interval parameters can be characterized as scaling and offset parameters to compress the vector's original magnitude distribution into the small discrete set of values.

The binary quantization engine 139 determines the first and second quantization boundary parameters a and b for each vector (or a subset of vectors) by performing an optimization to reduce (e.g., minimize) the error in the dot product between the vector being quantized and a vector near to it. In some examples, the optimization process is performed to determine the quantization interval such that the resulting quantization error satisfies a predetermined fidelity threshold. This fidelity threshold may correspond to a minimum acceptable reconstruction accuracy for the similarity score. The first quantization boundary parameter (a) may define the lower bound of the mapping interval, and the second quantization boundary parameter (b) defines the upper bound of the mapping interval. The quantization error is defined as the difference between the true dot product of the original float vector and the approximate dot product computed using the quantized vector after corrections are applied. The original float vector may be the adjusted data vector 106a. The quantized vector may be the resulting bit vector 106a.

This optimization process involves comparing the adjusted data vector 106a being quantized against a vector near to it to (e.g., minimize) the error in the dot product. The binary quantization engine 139 determines the first and second quantization boundary parameters a and by minimizing the quantization error for the dot product metric between a vector x being quantized and a neighboring vector y. When the binary quantization engine 139 solves for the quantization boundary parameters to reduce (e.g., minimize) the dot product error, it is effectively calculating the optimal scaling and offset to compress (e.g., needed to compress) the vector's original magnitude distribution into the small discrete set of values.

For any given pairs of vectors (x,y), where x is the adjusted data vector 106a being indexed and y is a vector near it, the quantization error E may be defined as the squared difference between the true dot product and the approximated dot product: E=x^{T}y−Q(x)^{T}y², where x^{T}y is the true dot product (e.g., the target value) and Q(x)^{T}y is the approximated dot product (e.g., the result of the quantized vector). The binary quantization engine 139 may determine the values for the first and second quantization boundary parameters that reduce (e.g., minimize) the sum of the quantization error over training pairs.

If the distribution of the components of the vector are known to be normally distributed then the expected mean square error (MSE) between the quantized vector and the floating point vector for a vector picked at random from the dataset can be computed exactly. In some examples, the mean and variance of the components of the vector are computed, m(x) and σ(x). In some examples, for a number (e.g., each number) of bits being used to represent the components of the quantized vector, a constant is computed that reduces (e.g., minimizes) the expected MSE. In some examples, this constant c is used to compute initial values for the quantization boundary parameters a and b. For example, this constant c is 0.798, 1.493 and 2.051 for 1 bit, 2 bits and 4 bits, respectively. The initial values for a and b are set to m(x)+c σ(x). In some examples, the intervals are further refined by minimizing the following error function

$${( Q ( x ) - x )}^{T} ( \frac{{xx}^{T}}{{\vert x \vert}^{2}} + λ ( I - \frac{{xx}^{T}}{{\vert x \vert}^{2}} ) ) ( Q ( x ) - x ) .$$

In some examples, λ is set to 0.1. This function is chosen to better preserve the error in the dot product which is more sensitive to errors parallel to the floating point vector x than errors perpendicular to it. The binary quantization engine 139 does this for an adjusted data vector 106a (x).

To find the optimal first and second quantization boundary parameters that reduce (e.g., minimize) the object function, the binary quantization engine 139 may perform a coordinate-descent type of iterative scheme that alternates between updating the components of the quantized vector by snapping to the new nearest quantization boundary parameter (a or b) and solving a closed-form solution derived from setting the derivative of the error function to zero to compute new quantization boundary parameters (a and b). This optimization process allows the binary quantization engine 139 to calculate the most effective quantization interval 175 to maximize the fidelity of the dot product approximation using the ultra-compressed bit representation.

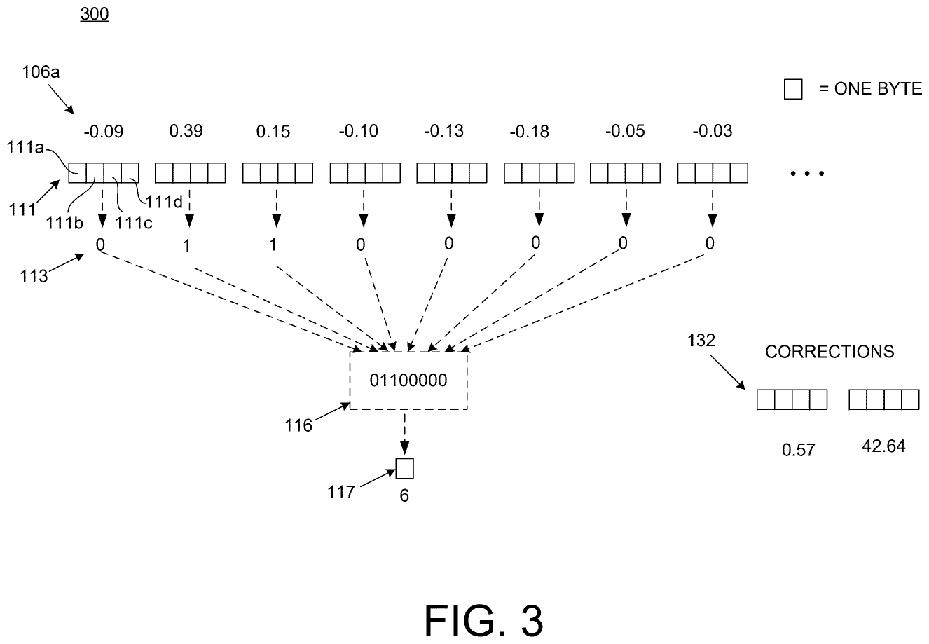

This optimization results in the application of a component-wise threshold rule to generate binary quantized bits 113 (as shown in FIG. 3). The binary quantization engine 139 applies the component-wise threshold rule to a floating point component of the adjusted data vectors 106a. If a component value of the adjusted data vector 106a is greater than

$$\frac{a + b}{2} ,$$

the binary quantization engine 139 assigns a binary value of one. If the value is less than or equal to

$$\frac{a + b}{2} ,$$

the binary quantization engine 139 assigns a binary value of zero. The application of this rule may produce one-bit-per-dimension encodings.

The binary quantization engine 139 then aggregates the binary quantized bits 113 in component order. In some examples, the binary quantization engine 139 packs eight binary quantized bits 113 into a single eight-bit byte. This packing operation generates the compact bit vector 116. In some examples, the resulting bit vector 116 is substantially smaller in memory footprint than the corresponding original data vector 106. As such, for the first quantization process for data vectors 106, the binary quantization engine 139 generates one-bit-per-dimension encodings, thereby reducing component values (e.g., float32 component value) into binary quantized bits 113 (see FIG. 3), which are then packed into a byte-aligned format to generate a bit vector 116 (e.g., a compact bit vector).

The index engine 108 includes a correction error engine 138 configured to compute error correction metadata 132 for a bit vector 116 of an index segment 114. The error correction metadata 132 includes one or more numerical values (e.g., error correction values) used to preserve information about the adjusted data vectors 106a that is contained in the boundary parameters a and b and is lost during generation of the bit vectors 116. It is also used to undo the centering of the original vectors. In some examples, the error correction metadata 132 includes one or more numerical values for centroid adjustment and one or more numerical values for quantization.

In some examples, the correction error engine 138 computes an error correction value for an adjusted data vector 106a by computing a residual difference between the adjusted data vector 106a and the corresponding bit vector 116 projected back into the same dimensional space. In some examples, the error correction metadata 132 includes a scaling factor that represents the difference between the quantization boundary parameters divided by the largest value which can be represented by the quantized vector component

$$\frac{b - a}{{2}^{n} - 1}$$

where n is the number of bits used to quantize the adjusted data vector 106a before quantization, and the scaling factor is used to reconstruct or approximate the original distance or similarity between vectors during a search operation.

In some examples, the error correction metadata 132 includes an additive correction factor per data vector proportional to the sum of components of the quantized data vector. In some examples the metadata 132 includes a per-vector dot product between the centroid m and the residual of the data vector x and the centroid to correct for centering: m^{t}(x−m). In some examples, the error correction metadata 132 includes multiple values, such as a scalar multiplier and a variance descriptor, that together increase reconstruction fidelity during similarity scoring.

The index engine 108 stores the bit vectors 116 and the error correction metadata 132 together in an index segment 114. In some examples, the bit vectors 116 are stored in a contiguous block within the index segment 114, and the error correction metadata 132 is stored in an adjacent metadata block associated with the bit vectors 116. In some examples, each bit vector 116 (or a subset of bit vectors 116) is stored in association with a corresponding error correction metadata 132, which allows the index engine 108 to retrieve both binary and magnitude information for a vector during a search operation. In some examples, the index engine 108 writes the index segment 114 to the vector database 110 after the bit vectors 116 and error correction metadata 132 have been generated.

The index engine 108 is configured to write the compressed data to the vector database 110. Following the computation of the bit vectors 116 by the binary quantization engine 139 and the error correction metadata 132 by the correction error engine 138, the index engine 108 generates the index segment 114. The index segment 114 stores the plurality of bit vectors 116 and the associated error correction metadata 132 in a contiguous, interleaved arrangement. This arrangement ensures that the compressed binary data and the magnitude correction information for a processed data vector 106 are stored efficiently together, allowing for high-throughput search operations where the data is read block-by-block

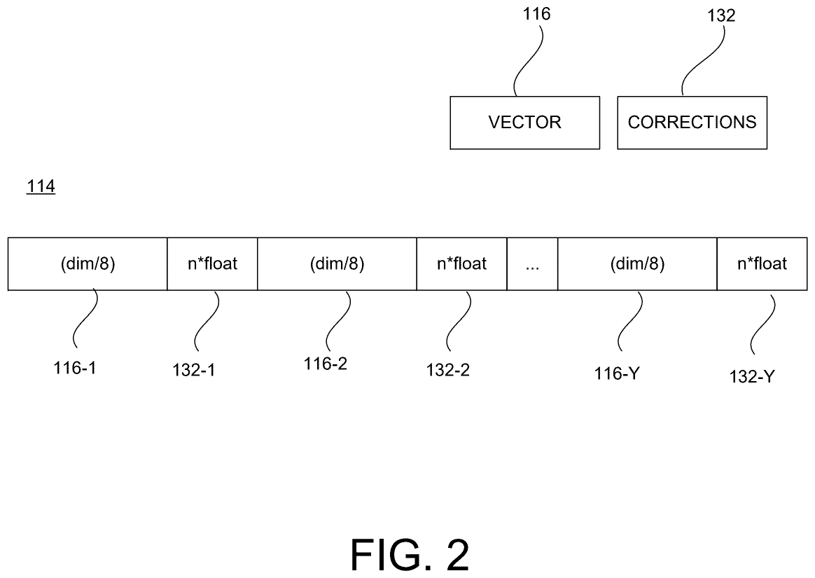

FIG. 2 illustrates an example of an index segment 114 that stores multiple bit vectors 116 and associated error correction metadata 132. The index segment 114 includes multiple stored bit vectors 116, and a stored bit vector 116 has a corresponding set of error correction metadata 132 generated by the correction error engine 138. As shown in FIG. 2, the index segment 114 includes a bit vector 116-1, error correction metadata 132-1 associated with the bit vector 116-1, a bit vector 116-2, error correction metadata 132-2 associated with the bit vector 116-2 and continues through a bit vector 116-Y and error correction metadata 132-Y associated with the bit vector 116-Y, where Y represents the total number of vectors stored in the index segment 114.

The structure of the index segment 114 may be stored in a file format (e.g., .veb) that sequentially stores the bit vector 116 and its associated error correction metadata 132. For each vector, the bit vector 116 is stored as (dim/8) number of bytes. The associated error correction metadata 132 is stored as n×float number of bytes. The n×float size indicates that the metadata is stored as n floating point values. In some examples, n=3 floating point values are stored for Euclidean distance, or n=3 floating point values are stored for dot product similarity. In some examples, the floating point values are stored at reduced precision such as bfloat16.

In some examples, a bit vector 116 is stored as a fixed-length binary encoding, where a bit corresponds to a dimension of the adjusted data vector 106a from which it was generated. In some examples, the bit vectors 116 are stored in a packed binary layout in the index segment 114 to reduce segment size and increase sequential read efficiency during retrieval. In some examples, a bit vector 116 is stored in association with a corresponding error correction metadata 132 value or values that maintain magnitude information lost during binary quantization.

In some examples, the error correction metadata 132 is stored adjacent to or interleaved with the bit vectors 116 within the index segment 114. In some examples, the index segment 114 stores a metadata header that identifies the number of bit vectors 116 in the segment, the dimensionality of the bit vectors 116, and the size or type of the associated error correction metadata 132. In some examples, the index segment 114 is stored in a format that allows block-level reading of consecutive bit vectors 116 and their associated error correction metadata 132 for high-throughput search operations.

FIG. 3 illustrates a quantization process 300 of generating bit vectors 116 using the binary quantization engine 139 of the index engine 108. The quantization process 300 may graphically depict the operation of the binary quantization engine 139. FIG. 3 depicts how floating-point component values of the adjusted data vectors 106a are converted from multi-byte numeric values into one-bit binary values and how those binary values are packed into a compressed byte that is ultimately stored in the vector index 112. In the example shown, eight floating-point component values are reduced to eight binary values, which are then packed into a single eight-bit byte, thereby reducing memory footprint by orders of magnitude relative to storing the original floating-point values.

As shown in FIG. 3, the index engine 108 generates adjusted data vectors 106a by offsetting the data vectors 106 relative to the representative point 136. An adjusted data vector 106a includes multiple floating-point component values, and FIG. 3 illustrates an example set of float values (e.g., −0.09, 0.39, 0.15, −0.10, −0.13, −0.18, −0.05, −0.03). FIG. 3 further depicts memory allocations 111 corresponding to each component of the adjusted data vectors 106a. A memory allocation 111 includes four one-byte containers 111a, 111b, 111c, 111d (or another number depending on floating-point precision), which represent the underlying encoded bytes of a single floating-point value. In this example, eight float values require thirty-two total bytes prior to quantization.

The binary quantization engine 139 converts a floating-point component of the adjusted data vectors 106a into a binary quantized bit 113 using a component-wise threshold rule. This threshold rule is the result of the optimization process, where the optimal threshold is calculated to reduce (e.g., minimize) the error in the dot product. If a component value of the adjusted data vector 106a is greater than the average of the quantization boundary parameters

$$\frac{a + b}{2} ,$$

the binary quantization engine 139 engine assigns a binary value of 1. If the value is less than or equal to the average of the quantization boundary parameters

$$\frac{a + b}{2} ,$$

the binary quantization engine 139 assigns a binary value of 0. Applying this rule to the eight float values shown in FIG. 3 results in eight binary quantized bits 113. In this example, the transformation reduces eight floating-point component values into eight one-bit binary values, shrinking the representation from thirty-two bytes to a single byte.

The binary quantization engine 139 is configured to generate a bit vector 116 by aggregating the binary quantized bits 113 in component order. In some examples, the binary quantization engine 139 packs eight binary quantized bits 113 into a single eight-bit byte. In some examples, the binary quantization engine 139 packs binary quantized bits 113 into a multi-byte representation, depending on vector dimensionality. In some examples, bit vectors 116 maintain consistent bit ordering across dimensions to ensure deterministic decoding, SIMD compatibility, and/or predictable memory alignment.

The index engine 108 stores the generated bit vector 116 into a byte container 117, where a byte container 117 corresponds to a packed representation of binary quantized bits 113 for an adjusted data vector 106a. In the example shown, a packed bit pattern of 01100000 corresponds to a decimal value of six. In some examples, storing a decimal equivalent of the binary byte enables direct index lookup, faster comparison operations, and/or hardware-optimized retrieval. In some examples, multiple byte containers 117 are stored contiguously to support block-aligned reads of many bit vectors 116.

FIG. 3 also illustrates error correction metadata 132 associated with a bit vector 116. The error correction metadata 132 includes one or more numerical values used to preserve magnitude information from the adjusted data vectors 106a. In some examples, the error correction metadata 132 is a scalar value computed from the adjusted data vector 106a. In some examples, the error correction metadata 132 includes a variance-based adjustment or multiple correction values that enable approximate reconstruction of similarity scores during search. In some examples, the error correction metadata 132 is stored alongside the bit vector 116 within the same index segment 114 so that retrieval of the bit vector 116 automatically provides access to the associated magnitude information.

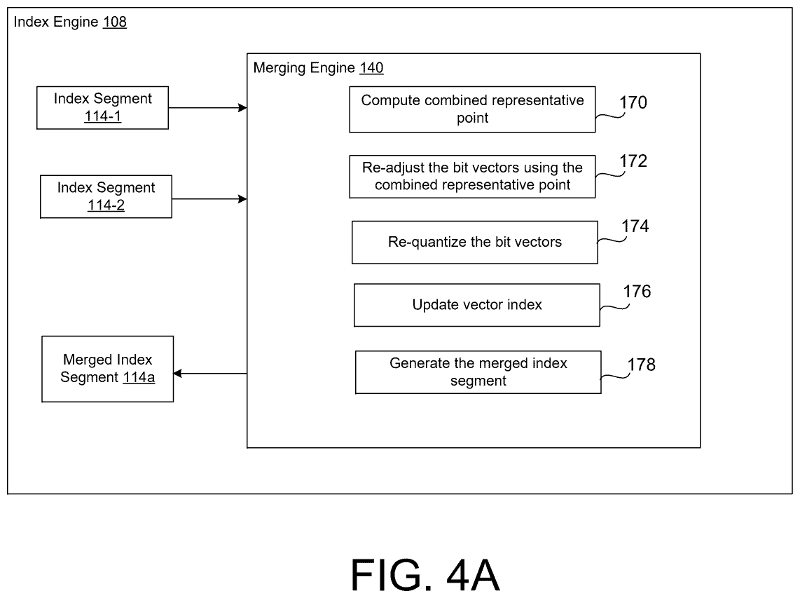

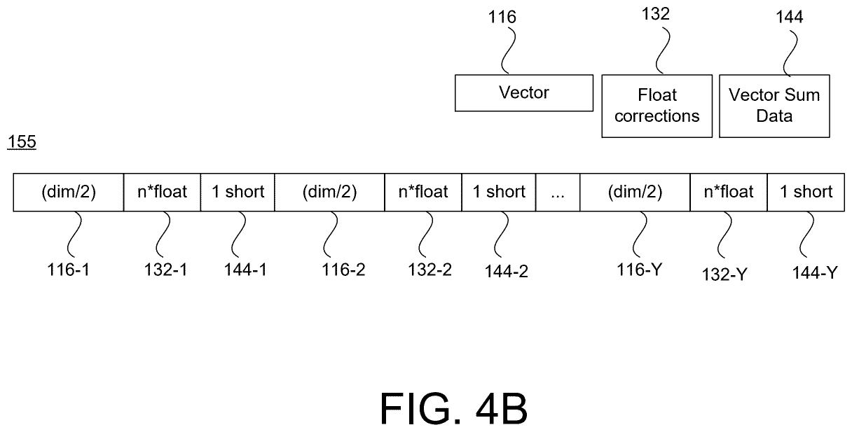

FIGS. 4A and 4B illustrate a merging engine 140 of the index engine 108 configured to generate a merged index segment 114a by merging a first index segment 114-1 and a second index segment 114-2. The first index segment 114-1 includes first bit vectors with corresponding interleaved error correction metadata 132. The second index segment 114-2 includes second bit vectors and corresponding interleaved error correction metadata 132. The first index segment 114-1 and the second index segment 114-2 have the persistent storage structure of the index segment 114 depicted in FIG. 2. The merging process may be used by the index engine 108 for maintaining index performance, particularly in systems utilizing an inverted vector file (IVF) index or a hierarchical navigable small world (HNSW) graph structure.

The merging engine 140 combines these two independently-generated segments into a single merged index segment 114a so that the vector index 112 may remain compact, searchable, and/or incrementally updated without retaining original float-precision data vectors 106.

As shown in FIG. 4A, the merging engine 140 receives the first index segment 114-1 and the second index segment 114-2. In some examples, merging is triggered when multiple index segments 114 accumulate, when a segment reaches a threshold size, or when the index engine 108 performs a maintenance or compaction cycle.

In operation 170, the merging engine 140 computes a combined representative point based on the bit vectors 116 and associated error correction metadata 132 of both index segments 114-1 and 114-2. The combined representative point represents the distribution of vectors across the two original segments as though they were a single unified dataset. In some examples, the combined representative point is computed using a weighted average of the representative points 136 (centroids) previously calculated for a segment. In some examples, the combined representative point is computed using the vector sum data 144 of each bit vector 116, which reflects the aggregate magnitude of the original adjusted data vectors 106a prior to quantization.

In operation 172, after determining the combined representative point, the merging engine 140 re-centers or re-adjusts both sets of bit vectors 116 relative to the combined representative point. Because bit vectors 116 store only binary sign information, and because the original centered float values are not retained, the merging engine 140 may use the error correction metadata 132 and vector sum data 144 to reconstruct approximate magnitude information so that vectors can be re-quantized consistently.

In operation 174, the merging engine 140 then re-quantizes all re-adjusted vectors from the first index segment 114-1 and the index segment 114-2 using a temporary file 155. In some examples, during operation 174, the merging engine 140 may generate a temporary file 155 (e.g., .qvec.tmp) that stores a higher-precision reconstruction of the vectors, as shown in FIG. 4B. The use of int4 data ensures that scoring steps, such as diversity and reverse-link scoring during HNSW graph update, are performed with the necessary fidelity to maintain graph quality. In some examples, this re-quantization process produces new bit vectors 116 and new error correction metadata 132 for the merged index segment 114a.

FIG. 4B illustrates an example of the structure of the temporary file 155. The temporary file 155 stores a vector using asymmetric quantization where the vector is quantized as an int4 query vector. The structure of the temporary file 155 includes a repeating pattern for each vector Y: a bit vector 116-Y (e.g., sized (dim/2)), associated error correction metadata 132-Y, and vector sum data 144-Y. The (dim/2) size corresponds to the use of a 4-bit (int4) representation. The vector sum data 144 stores magnitude information used to re-quantize vectors during merging and may be retained so that future merges can be performed without reverting to float precision data.

The temporary file 155 includes a bit vector 116-1, error correction metadata 132-1 associated with the bit vector 116-1, vector sum data 144-1 associated with the bit vector 116-1, and similarly includes a bit vector 116-2, error correction metadata 132-2 associated with the bit vector 116-2, and vector sum data 144-2 associated with the bit vector 116-2, continuing through a bit vector 116-Y, error correction metadata 132-Y associated with the bit vector 116-Y, and vector sum data 144-Y associated with the bit vector 116-Y. In operation 176, after re-quantization completes, the merging engine 140 updates the vector index 112, replacing the two original segments 114-1 and 114-2 with the merged segment 114a. In some examples, this update process may free memory and storage previously occupied by the two original segments, reducing fragmentation and improving search efficiency.

In operation 178, the merging engine 140 generates the merged index segment 114a, which contains newly-generated bit vectors 116, and updated error correction metadata 132. The merged segment 114a has consistent quantization across vectors that originally belonged to separate segments.

After the merged index segment 114a is finalized, the temporary file 155 is deleted, and only the compact bit vectors 116 and reduced error correction metadata 132 remain stored in the vector index 112.

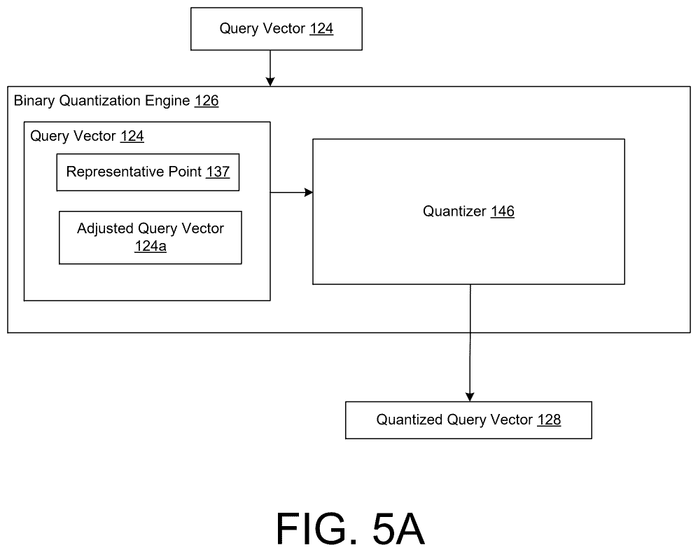

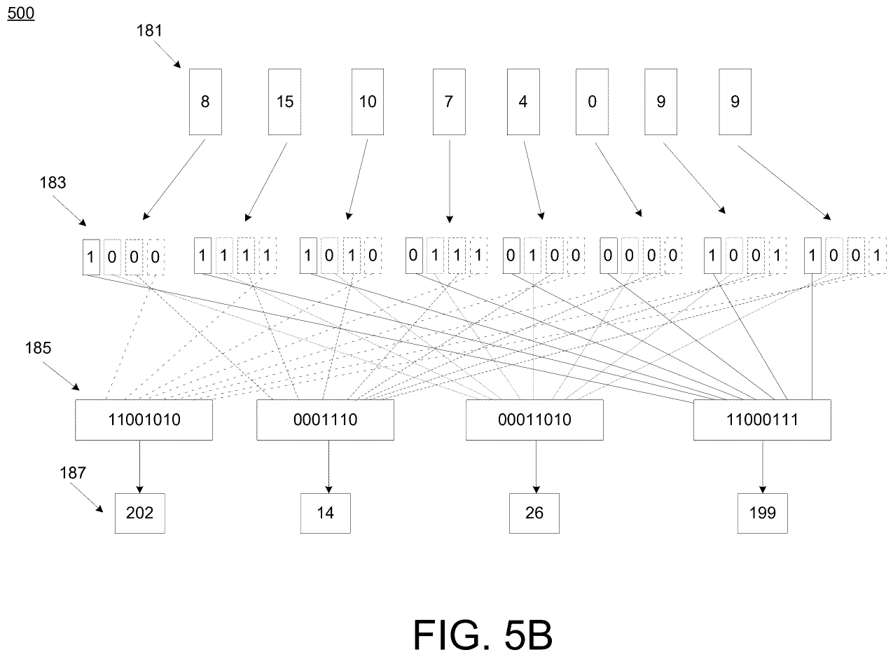

FIG. 5A illustrates a binary quantization engine 126 configured to generate a quantized query vector 128 from a query vector 124 generated by the embedding model 104. The binary quantization engine 126 may be included in a search engine 120 and may operate during a search process, rather than during indexing. The binary quantization engine 126 operates asymmetrically relative to the index engine 108, which generates a higher-precision encoding of the query vector 124 compared to the one-bit encoding of the stored bit vectors 116. In other words, in contrast to the binary quantization engine 139 that converts adjusted data vectors 106a into one-bit per-dimension bit vectors 116, the binary quantization engine 126 may generate a higher-precision encoding of the query vector 124 so that search accuracy is maintained even though the stored vectors in the vector index 112 are one-bit representations. FIG. 5A therefore may illustrate an asymmetric processing flow in which index-time quantization and search-time quantization are not the same.

The search engine 120 may receive a search query 122 through an input field 165 displayed by an application 115 executing on a computing device 102. The search query 122 may be text, audio, or visual content supplied by a user. The embedding model 104 may convert the search query 122 into a query vector 124, and, in some examples, the query vector 124 is a multi-dimensional query vector that includes floating-point values representing semantic, contextual, or visual meaning extracted from the input. In some examples, the query vector 124 is referred to as a query embedding. The query vector 124 may therefore be similar in structure to the data vectors 106 described earlier but is processed separately for search.

The binary quantization engine 126 may compute a representative point 137 for the query vector 124. The representative point 137 is a single reference point in vector space that represents the component distribution of the query vector 124, similar in form to the representative point 136 computed for an index segment 114. In some examples, the representative point 137 is a centroid computed from the component values of the query vector 124.

The binary quantization engine 126 may generate an adjusted query vector 124a by adjusting the query vector 124 relative to the representative point 137. In some examples, the adjusted query vector 124a is created by subtracting the representative point 137 from each component of the query vector 124 so that the representative point becomes the origin of the coordinate space. The adjusted query vector 124a maintains the same dimensionality as the original query vector 124 but is re-centered for quantization.

The binary quantization engine 126 includes a quantizer 146 that converts the adjusted query vector 124a into a quantized query vector 128 using a second quantization process. This second quantization process is asymmetric and may map component values into multiple discrete bins based on magnitude. For example, the second quantization process may encode the query vector 124 with multiple bits per dimension (e.g., int4) providing more granularity than the one-bit encoding used at index time. In some examples, the second quantization process maps component values into multiple discrete bins based on magnitude, where the number of bins corresponds to the number of bits assigned to each dimension. For instance, a four-bit per-dimension encoding yields sixteen possible bin assignments, which provide more granularity than the one-bit encoding used at index time.

The resulting quantized query vector 128 therefore maintains magnitude differentiation, allowing the search engine 120 to compute similarity against one-bit bit vectors 116 stored in the vector index 112 with greater fidelity. In some examples, the asymmetry means the stored vectors are encoded using one bit per dimension, while the query vector 124 may be encoded with more than one bit per dimension. The additional precision of the quantized query vector 128 may preserve magnitude detail that is lost in the one-bit segment representation, allowing the query to remain expressive even when compared to heavily compressed bit vectors 116.

The quantizer 146 executes the second quantization process, which may involve a form of asymmetric optimized scalar quantization, converting the adjusted query vector 124a into the quantized query vector 128. This process relaxes the constraint that the query embedding (e.g., the query vector 124) and document embeddings (e.g., data vectors 106) use the same centroid (or representative point) for centering.

For a document embedding y (e.g., a data vector 106) centered around a representative point m_{y} and a query vector 124 (x) centered around a query representative point mₓ, the quantizer 146 may estimate a dot product x^{t}y decomposing the calculation:

$${x}^{t} y = {m}_{y}^{t} x + {m}_{x}^{t} ( y - {m}_{y} ) + {( x - {m}_{x} )}^{t} ( y - {m}_{y} ) .$$

The quantizer 146 is configured to compute an estimate of this dot product using three component terms, two of which are scalar corrections.

The first term is the query correction term

$$( \begin{matrix}t \\ y\end{matrix} ) ( {m}_{y}^{t} x )$$

is a scalar value computed once per query (x) and used to process the whole posting listing of document vectors. The second term is the document correction term

$$( {m}_{x}^{t} ( y - {m}_{y} ) ) ,$$

which is a scalar value that is computed once per document (y) and cached with the quantized document embeddings (e.g., with the bit vector 116), representing the interaction between the query's center mₓ and the adjusted document residual y−m_{y}. This replaces the scalar m^{t}(x−m) that is stored when the vectors use the same centre so represents no additional storage.

The third term is the quantized residual term (x−mₓ)^{t}(y−m_{y}), which may be core component estimated using the binary quantization methodology, where the query residual (x−mₓ) and document residual (y−m_{y}) vectors are quantized, and the dot product value is estimated from these quantized vectors.

This asymmetric centering allows the quantizer 146 to efficiently manage the search process in IVF structures. In some examples, document centroids are clustered into a smaller number of query centroids (k_{q}<k_{d}). This means there is a many-to-one mapping from the document representative points (m_{y}) to the query representative points (mₓ). The quantizer 146 may only need to quantize the query vector 124 (x) against the document representative points at most k_{q} times, which may reduce (e.g., significantly reduce) the computational bottleneck during search. The final similarity score is computed by summing the contributions of the three decomposed terms.

FIG. 5B illustrates a quantization process 500 for generating a quantized query vector 128 by the quantizer 146. FIG. 5B depicts the intermediate result of the second quantization process as a set of quantized values 181 (e.g., eight values quantized to int4). These quantized values 181 are the integer results corresponding to the dimensions of the adjusted query vector 124a. Below the quantized values 181 is the binary representation 183. The binary representation 183 expresses a quantized value as a 4-bit binary code (e.g., if four bits are assigned to each component of the adjusted query vector 124a).

The quantizer 146 generates translated query components 185 by bit-shifting and aligning the binary representation 183 of a quantized query component. The process reorganizes the bits so that bits (e.g., all bits) at the same positional value (e.g., the first bit of every component) are grouped together into a separate, compressed byte. This produces one byte per bit-position rather than one byte per dimension. If four bits are assigned to each component of the query vector 124, then four separate bytes are produced, collectively forming the translated query components 185. This bit-slicing process produces compact, byte-aligned translated query components 185.

FIG. 5B shows example byte-aligned values such as 11001010 or 00001110, which reflect the bit-sliced encoding of the quantized query vector 128. FIG. 5B further illustrates decimal byte values 187, which represent the decimal interpretation of each translated query component 185. Converting to decimal values may allow for faster lookup, cache locality improvements, and/or hardware acceleration during similarity evaluation. The translated query components 185 are the representation that the search engine 120 uses when comparing the quantized query vector 128 against the bit vectors 116 stored in an index segment 114.

The quantized query vector 128 may allow the search engine 120 to perform a fast dot-product approximation by looping over the bytes of the translated query components 185 and performing bitwise operations against corresponding bytes of the bit vectors 116 stored in the vector index 112. Because each byte represents the collective first, second, third, or fourth bit of the dimensions, bitwise processing can be applied to multiple dimensions simultaneously. In some examples, the translated query components 185 enable a vectorized similarity computation using CPU SIMD instructions or GPU warps, which substantially increases throughput relative to scalar or floating-point comparison.

This representation also supports the asymmetric quantization process described above. The stored vectors remain compressed as one-bit per-dimension bit vectors 116, while the query vector 124 maintains multiple bits per dimension through the translated query components 185. The search engine 120 aligns these representations by performing bitwise compare operations against each bit position independently, allowing magnitude information to influence the scoring process without decompressing the index.

The search engine 120 computes similarity between the quantized query vector 128 and the stored bit vectors 116 using the error correction metadata 132 to refine scoring accuracy. During scoring, the search engine 120 performs bitwise comparison operations between components of the quantized query vector 128 and corresponding components of a stored bit vector 116. In some examples, similarity is computed by counting matching bits (e.g., Hamming-style similarity), accumulating weighted scores for a bit position, or computing bit-dot-product approximations using the translated query components described in FIG. 5B.

In some examples, the error correction metadata 132 is applied during scoring to restore magnitude information lost during binary quantization. The error correction metadata 132 may store a compressed representation of the original float magnitudes for a bit vector 116, which allows the scoring engine to adjust similarity scores according to the magnitude distribution of the original data vectors 106. This asymmetric evaluation—where stored vectors are represented as one-bit encodings and the query vector 124 is represented as multi-bit quantized values—permits high-fidelity ranking while maintaining extremely compact index storage.

In some examples, the search engine 120 computes similarity between the quantized query vector 128 and stored bit vectors 116 using hardware-accelerated instruction execution. In some examples, the bit vectors 116 are stored as byte-aligned binary sequences, enabling evaluation of multiple bit positions in parallel using processor vector-register operations. In some examples, the search engine 120 executes bitwise logical operations, including population-count, bitwise-AND, bitwise-XOR, and bit-shift instructions, over byte slices of the translated query components 185 and corresponding byte-aligned slices of stored bit vectors 116. This allows the search engine 120 to evaluate similarity across multiple dimensions per instruction rather than on a component-by-component basis.

In some examples, the translated query components 185 are formatted so that each byte contains one bit from each of multiple dimensions, allowing one register to evaluate bit states for many dimensions of the quantized query vector 128 simultaneously. In some examples, the search engine 120 utilizes processor instruction sets such as AVX, SSE, or NEON to perform parallel bit evaluation. In some examples, the hardware execution path produces an intermediate similarity score derived from matching bit positions, which is subsequently adjusted using the error correction metadata 132 to refine similarity.

In some examples, the search engine 120 selectively evaluates stored bit vectors 116 by computing partial similarity scores and terminating evaluation early if a stored vector cannot exceed a relevance threshold. In some examples, the search engine 120 compares a subset of the translated query components 185 to corresponding portions of a stored bit vector 116 and computes an intermediate similarity score. If the intermediate score is below a threshold that would allow the bit vector 116 to remain in contention, the search engine 120 stops the comparison for that vector. In some examples, thresholding is applied sequentially over byte slices so that evaluation may terminate before all bits of the bit vector 116 are processed.

In some examples, branch-and-bound pruning is applied at the cluster selection stage as well. If the similarity between the quantized query vector 128 and a cluster representative point 136 does not meet a selection bound, the search engine 120 bypasses stored vectors in that segment without loading or scoring them. This allows the search engine 120 to evaluate multiple index segments 114 in parallel while selectively skipping irrelevant segments based on centroid proximity or partial similarity.

In some examples, the search engine 120 identifies an oversampled subset of stored bit vectors 116 prior to producing final results. In some examples, the search engine 120 selects a candidate set larger than the requested result count based on bitwise similarity alone. After selecting the candidate set, the search engine 120 retrieves and applies associated error correction metadata 132 to compute a corrected similarity score for a stored bit vector 116 in the candidate set. In some examples, this refinement is computed only for the oversampled subset rather than the full index segment 114.

In some examples, the search engine 120 generates a re-ranked result order using the corrected similarity scores. In some examples, bitwise similarity contributes the base ranking while error correction metadata 132 contributes magnitude restoration, producing a refined order for the oversampled candidate set without reconstructing original floating-point vectors.

In some examples, the search engine 120 computes an estimated dot-product between the quantized query vector 128 and a stored bit vector 116 using the combination of bit-similarity and the corresponding error correction metadata 132. In some examples, the search engine 120 computes an estimated inner-product score using the number of matching bit positions from the bitwise similarity computation and a magnitude factor encoded in the error correction metadata 132. In some examples, error correction metadata 132 includes a per-vector magnitude value, a constant, or a compressed measure of the vector norm from the original adjusted data vectors 106a.

In some examples, the search engine 120 computes a similarity metric as a weighted combination of bitwise similarity counts and correction factors. In some examples, the estimated dot-product is computed without reconstructing original floating-point values. In some examples, this estimation is applied as the final ranking stage following oversample candidate selection.

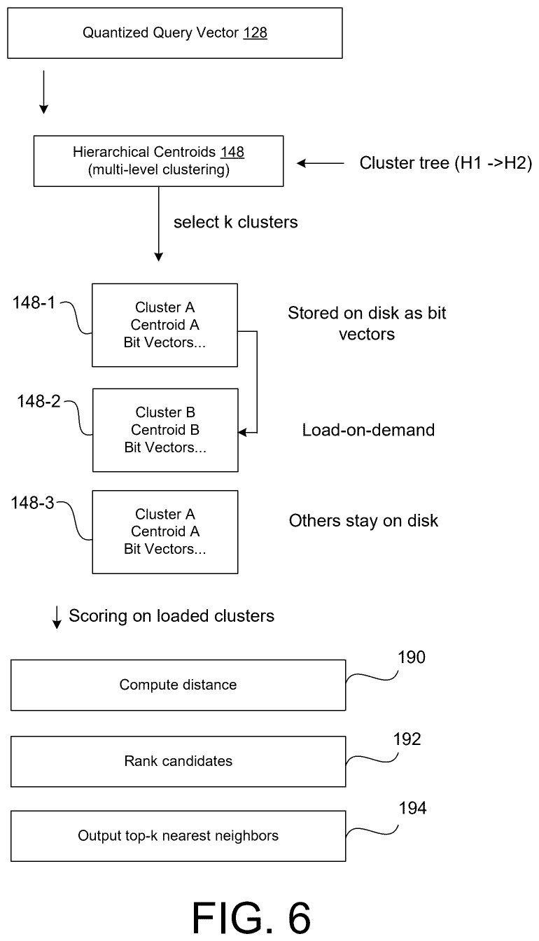

FIG. 6 illustrates a technique in which the vector index 112 is arranged into vector clusters rather than stored as a single flat sequence of bit vectors 116. A vector cluster refers to a grouping of stored bit vectors 116 that are located within the same region of the vector space.

A cluster includes a subset of the bit vectors 116, corresponding error correction metadata 132, and one or more hierarchical centroids 148. A hierarchical centroid 148 is a representative reference point used to characterize the location of a cluster in the vector space. The hierarchical centroids 148 define multiple levels of spatial granularity, shown in FIG. 6 as a cluster tree (H1→H2). Higher-level centroids represent broader partitions where many vectors may fall, while lower-level centroids represent more specific and densely separated groupings. Using a hierarchy of centroids enables a tiered navigation approach in which the search engine 120 first performs a coarse-resolution comparison against high-level centroids, and then progressively narrows comparisons to lower-level centroids only where appropriate.

As depicted in FIG. 6, separate regions of the vector space are represented by Cluster A and Cluster B, each shown with a centroid (for example, Centroid A and Centroid B) and a corresponding set of compressed bit vectors 116 that may be stored on disk. Rather than requiring the entire vector index 112 to reside in memory simultaneously, the clusters (e.g., only the clusters) determined to be relevant to a specific query are loaded at execution time. This design reduces memory footprint, improves scalability for large-scale datasets, and enables vector search to extend far beyond the amount of memory typically required for graph-based approaches.

In some examples, the index engine 108 constructs these clusters during indexing. The index engine 108 receives incoming data vectors 106, adjusts them using representative points 136, and generates corresponding bit vectors 116 as previously described with respect to FIGS. 1 to 5. Placement of a bit vector 116 into a specific cluster is determined according to similarity between a bit vector 106 and one or more hierarchical centroids 148. In some examples, cluster boundaries are generated using iterative or recursive clustering processes (e.g., hierarchical k-means or other recursive partitioning methods).

FIG. 6 illustrates centroid hierarchy nodes 148-1, 148-2, and 148-3, where 148-1 may correspond to a top-level centroid representing a large portion of the dataset and 148-3 may represent a more finely-divided subregion. Because each cluster maintains an independent association with its bit vectors 116 and error correction metadata 132, a single cluster can be retrieved and loaded without requiring the entire vector index 112 to be present in memory at once.

This behavior may enable the vector index 112 to scale to arbitrarily large corpora while maintaining efficient retrieval properties. Flat indexes and full-RAM graph structures degrade once memory limits are reached, whereas the clustered configuration shown in FIG. 6 continues to function even when most of the index is disk-resident.

During retrieval, the search engine 120 generates a query vector 124 from the search query 122 and converts the query vector 124 into a quantized query vector 128 using the asymmetric multi-bit quantization process described in FIGS. 5A-5B. The search engine 120 compares the query vector 124 against the hierarchical centroids 148 to determine which clusters most closely resemble the query vector 124. The comparison may begin at the certain (e.g., highest) centroid layer to eliminate large unrelated regions efficiently, after which lower-level centroids associated with promising partitions are evaluated. This cluster-based selection reduces the amount of data to be loaded and scored, improving performance without requiring full-index scanning.

Once a subset of clusters has been selected based on centroid proximity, the search engine 120 loads the associated bit vectors 116 and error correction metadata 132 from disk via the load-on-demand mechanism. FIG. 6 illustrates this retrieval sequence beginning with operation 190 (Compute Distance). In operation 190, the search engine 120 performs a bulk, hardware-accelerated comparison between the loaded bit vectors 116 and the quantized query vector 128. This scoring involves computing the preliminary bitwise similarity, which includes the accumulation of weighted bit-counts, and applying the scalar correction terms derived from the asymmetric quantization decomposition.

Next, in operation 192 (Rank Candidates), the search engine 120 uses the preliminary similarity scores to identify a set of candidate vectors that are most relevant to the query. This step may involve selecting an oversampled subset of the best-scoring bit vectors 116 and retrieving their associated error correction metadata 132 to compute a refined, corrected similarity score for final ranking.

In operation 194 (Output Top-K Nearest Neighbors), the search engine 120 generates a re-ranked result order based on the corrected similarity scores and returns the top-k nearest neighbor results. This complete sequence allows the search engine 120 to provide high-recall results with low latency despite the index segments residing on disk.

This load-on-demand design provides high-recall search capability with significantly lower memory cost than full-graph designs, while maintaining high throughput due to compressed representation and centroid-based routing. Because the clusters most relevant to the query are fetched, the vector index 112 remains largely disk-resident, reducing memory pressure and enabling efficient similarity search across extremely large datasets. This load-on-demand design provides high-recall search capability with significantly lower memory cost than full-graph designs, while maintaining high throughput due to compressed representation and centroid-based routing.

Referring back to FIG. 1A, the computing device 102 may be any type of computing device that includes one or more processors 101, one or more memory devices 103, and an operating system 105 configured to execute (or assist with executing) an application 115. The application 115 may be a program configured to communicate with the data management platform 152. In some examples, the application 115 is a native application installable on the operating system 105. In some examples, the application 115 is a web application executable by a browser application. In some examples, the application 115 is a web page executable by a browser application. In some examples, the computing device 102 is a laptop computer. In some examples, the computing device 102 is a desktop computer. In some examples, the computing device 102 is a tablet computer. In some examples, the computing device 102 is a smartphone. In some examples, the computing device 102 is a wearable device (e.g., a head-mounted display device such as an augmented reality (AR) or a virtual reality (VR) device).

The processor(s) 101 may be formed in a substrate configured to execute one or more machine executable instructions or pieces of software, firmware, or a combination thereof.

The processor(s) 101 can be semiconductor-based—that is, the processors can include semiconductor material that can perform digital logic. The memory device(s) 103 may include a main memory that stores information in a format that can be read and/or executed by the processor(s) 101. The memory device(s) 103 may store the operating system 105, including the application 115 that, when executed by the processors 101, performs certain operations discussed herein. In some examples, the memory device(s) 103 store one or more portions of the data management platform 152 that, when executed by the processors 101, performs certain operations discussed with reference to the data management platform 152. In some examples, the memory device(s) 103 includes a non-transitory computer-readable medium that includes executable instructions that cause at least one processor (e.g., the processors 101) to execute the operations discussed herein.

The server computer 160 may be computing devices that take the form of a number of different devices, for example a standard server, a group of such servers, or a rack server system. The server computer 160 may represent a single server computer or multiple server computer. In some examples, the server computer 160 may represent multiple server computers that are in communication with each other. In some examples, the server computer 160 may be a single system sharing components such as processors and memories. In some examples, the server computer 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within the network. The network 150 may further include any number of hardwired and/or wireless connections.

The server computer(s) 160 may include one or more processors 151 formed in a substrate, an operating system (not shown) and one or more memory devices 153. The memory device(s) 153 may represent any kind of (or multiple kinds of) memory (e.g., RAM, flash, cache, disk, tape, etc.). In some examples, the memory devices 153 may include external storage, e.g., memory physically remote from but accessible by the server computer(s) 160. The processor(s) 151 may be formed in a substrate configured to execute one or more machine executable instructions or pieces of software, firmware, or a combination thereof. The processor(s) 151 can be semiconductor-based—that is, the processors can include semiconductor material that can perform digital logic. The memory device(s) 153 may store information in a format that can be read and/or executed by the processor(s) 151. The memory device(s) 153 may store one or more portions of the data management platform 152, that, when executed by the processor(s) 151, perform certain operations discussed herein. In some examples, the memory device(s) 153 includes a non-transitory computer-readable medium that includes executable instructions that cause at least one processor (e.g., the processor(s) 151) to execute operations.

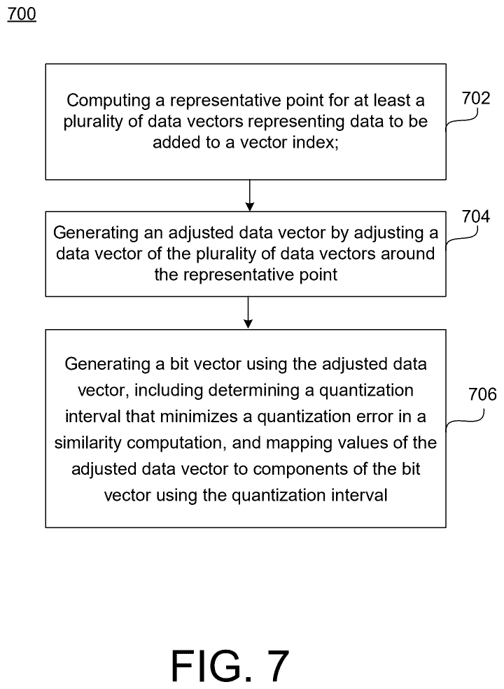

FIG. 7 is a flowchart 700 depicting example operations of binary vector quantization for converting multi-dimensional data vectors into binary vectors according to an aspect. The flowchart 700 may depict operations of a computer-implemented method. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion.

Operation 702 includes computing a representative point for at least a plurality of data vectors representing data to be added to a vector index. Operation 704 includes generating an adjusted data vector by adjusting a data vector of the plurality of data vectors around the representative point. Operation 706 includes generating a bit vector using the adjusted data vector, including determining a quantization interval that reduces a quantization error in a similarity computation and mapping values of the adjusted data vector to components of the bit vector using the quantization interval.

In some examples, prior to operation 702, the data vectors may undergo a transformation via a sparse preconditioning matrix to make the components distribution approximately normal. This is a technical advantage over prior art that either may not account for component distribution or use a more expensive dense preconditioning matrix, which subsequently improves the robustness of the quantization process. The components that the transform makes normally distributed are the individual dimensional values (e.g., the floating-point values) that make up each data vector.

The adjustment in operation 704 may include centering the data vectors around the computed representative point (e.g., a cluster centroid) by subtracting the representative point from each component. This centering operation may create the adjusted data vector 106a (or residual vector), maintaining the same dimensionality as the original data vector. This residual vector may be beneficial because it isolates the local deviations of each vector, which are the components used for accurate local similarity searches.

The quantization process described in operation 706 may determine a quantization interval on a per-vector basis through an optimization process. The quantization interval may be defined by quantization boundary parameters. This optimization may involve first minimizing the expected square error of the quantized vector compared to the original vector followed by direct optimization of the square dot product error between the vector and one close to parallel with it. By computing (e.g., directly computing) the scaling factors for the quantization boundary parameters, the resulting bit vector may maintain high fidelity for dot product approximation. This may be a technical advantage over methods that use static or global quantization thresholds. The resulting bit vector may be a compact one-bit-per-dimension encoding.
Clause 1. A method comprising: computing a representative point for at least a plurality of data vectors representing data to be added to a vector index; generating an adjusted data vector by adjusting a data vector of the plurality of data vectors around the representative point; and generating a bit vector using the adjusted data vector, including: determining a quantization interval that reduces a quantization error in a similarity computation; and mapping values of the adjusted data vector to components of the bit vector using the quantization interval.
Clause 2. The method of clause 1, wherein determining the quantization interval includes: determining a first boundary parameter and a second boundary parameter; executing a comparison of the adjusted data vector with a neighboring vector; and adjusting the first boundary parameter and the second boundary parameter based on the comparison to reduce the quantization error in the similarity computation.
Clause 3. The method of clause 1, wherein the representative point is a first representative point, wherein the bit vector is generated using a first quantization process, the method further comprising: generating an adjusted query vector by adjusting a query vector around a second representative point; and generating a quantized query vector by applying a second quantization process to the adjusted query vector, the second quantization process being different from the first quantization process.
Clause 4. The method of clause 3, further comprising: estimating a similarity metric between the quantized query vector and the bit vector using a decomposition of a dot product.
Clause 5. The method of clause 4, wherein the decomposition includes at least one of: a query correction term derived from the second representative point and the query vector; a data correction term derived from the first representative point and the bit vector; and a quantized residual term derived from a comparison of the quantized query vector and the bit vector.
Clause 6. The method of clause 1, further comprising: applying an orthogonal transformation to the plurality of data vectors using a preconditioning matrix, wherein the preconditioning matrix is configured to cause the components of the plurality of data vectors to be approximately normally distributed.
Clause 7. The method of clause 1, further comprising: generating error correction metadata corresponding to a plurality of bit vectors; and storing the plurality of bit vectors and the error correction metadata in an index segment of the vector index, the error correction metadata being interleaved with the plurality of bit vectors.
Clause 8. The method of clause 7, wherein storing the plurality of bit vectors into the index segment includes packing a plurality of quantized bit values into a byte-aligned bit vector format.
Clause 9. The method of clause 7, wherein the index segment is a first index segment, the plurality of bit vectors includes first bit vectors, the method further comprising: merging the first index segment with a second index segment having second bit vectors, including: computing a combined representative point for the first index segment and the second index segment; generating adjusted bit vectors for the first bit vectors and the second bit vectors based on the combined representative point; and generating quantized bit vectors using the adjusted bit vectors.
Clause 10. An apparatus comprising: a database storing a vector index; and an index engine including executable instructions that cause at least one processor to: compute a representative point for at least a plurality of data vectors representing data to be added to the vector index; generate an adjusted data vector by adjusting a data vector of the plurality of data vectors around the representative point; and generate a bit vector using the adjusted data vector, including: determine a quantization interval that reduces (e.g., minimizes) a quantization error in a similarity computation; and map values of the adjusted data vector to components of the bit vector using the quantization interval.
Clause 11. The apparatus of clause 10, wherein the executable instructions include instructions that cause the at least one processor to: determine a first boundary parameter and a second boundary parameter; execute a comparison of the adjusted data vector with a neighboring vector; and adjust the first boundary parameter and the second boundary parameter based on the comparison to reduce the quantization error in the similarity computation.
Clause 12. The apparatus of clause 10, wherein the representative point is a first representative point, wherein the bit vector is generated using a first quantization process, wherein the executable instructions include instructions that cause the at least one processor to: generate an adjusted query vector by adjusting a query vector around a second representative point; and generate a quantized query vector by applying a second quantization process to the adjusted query vector, the second quantization process being different from the first quantization process.
Clause 13. The apparatus of clause 10, wherein the executable instructions include instructions that cause the at least one processor to: estimate a similarity metric between the quantized query vector and the bit vector using a decomposition of a dot product.
Clause 14. The apparatus of clause 13, wherein the decomposition includes at least one of: a query correction term derived from the second representative point and the query vector; a data correction term derived from the first representative point and the bit vector; and a quantized residual term derived from a comparison of the quantized query vector and the bit vector.
Clause 15. The apparatus of clause 10, wherein the executable instructions include instructions that cause the at least one processor to: apply an orthogonal transformation to the plurality of data vectors using a preconditioning matrix, wherein the preconditioning matrix is configured to cause the components of the plurality of data vectors to be approximately normally distributed.
Clause 16. The apparatus of clause 10, wherein the executable instructions include instructions that cause the at least one processor to: generate error correction metadata corresponding to a plurality of bit vectors; and store the plurality of bit vectors and the error correction metadata in an index segment of the vector index, the error correction metadata being interleaved with the plurality of bit vectors.
Clause 17. A non-transitory computer readable medium storing executable instructions that cause at least one processor to execute operations, the operations comprising: computing a representative point for at least a plurality of data vectors representing data to be added to a vector index; generating an adjusted data vector by adjusting a data vector of the plurality of data vectors around the representative point; and generating a bit vector using the adjusted data vector, including: determining a quantization interval that reduces a quantization error in a similarity computation; and mapping values of the adjusted data vector to components of the bit vector using the quantization interval.
Clause 18. The non-transitory computer readable medium of clause 17, wherein the operations further comprise: determining a first boundary parameter and a second boundary parameter; executing a comparison of the adjusted data vector with a neighboring vector; and adjusting the first boundary parameter and the second boundary parameter based on the comparison to reduce the quantization error in the similarity computation.
Clause 19. The non-transitory computer readable medium of clause 17, wherein the representative point is a first representative point, wherein the bit vector is generated using a first quantization process, the operations further comprising: generating an adjusted query vector by adjusting a query vector around a second representative point; and generating a quantized query vector by applying a second quantization process to the adjusted query vector, the second quantization process being different from the first quantization process.
Clause 20. The non-transitory computer readable medium of clause 19, wherein the operations further comprise: estimating a similarity metric between the quantized query vector and the bit vector using a decomposition of a dot product, wherein the decomposition includes a query correction term derived from the second representative point and the query vector, a data correction term derived from the first representative point and the bit vector, and a quantized residual term derived from a comparison of the quantized query vector and the bit vector.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., an OLED (Organic light emitting diode) or LCD (liquid crystal display) monitor) for displaying information to the user and a keyboard and a pointing device (e.g., a mouse or a trackball) by which the user can provide input to the computer. Alternatively, this can be implemented with a 3D user interaction system making use of trackers that are tracked in orientation and 3D position. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art. Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
generating a representative point for at least a plurality of data vectors representing data to be added to a vector index;
generating an adjusted data vector by adjusting a data vector of the plurality of data vectors around the representative point; and
generating a bit vector using the adjusted data vector, including:
determining a quantization interval that reduces a quantization error in a similarity computation; and
mapping values of the adjusted data vector to components of the bit vector using the quantization interval.

2. The method of claim 1, wherein determining the quantization interval includes:
determining a first boundary parameter and a second boundary parameter;
executing a comparison of the adjusted data vector with a neighboring vector; and
adjusting the first boundary parameter and the second boundary parameter based on the comparison to reduce the quantization error in the similarity computation.

3. The method of claim 1, wherein the representative point is a first representative point, wherein the bit vector is generated using a first quantization process, the method further comprising:
generating an adjusted query vector by adjusting a query vector around a second representative point; and
generating a quantized query vector by applying a second quantization process to the adjusted query vector, the second quantization process being different from the first quantization process.

4. The method of claim 3, further comprising:
estimating a similarity metric between the quantized query vector and the bit vector using a decomposition of a dot product.

5. The method of claim 4, wherein the decomposition includes at least one of:
a query correction term derived from the second representative point and the query vector;
a data correction term derived from the first representative point and the bit vector; and
a quantized residual term derived from a comparison of the quantized query vector and the bit vector.

6. The method of claim 1, further comprising:
applying an orthogonal transformation to the plurality of data vectors using a preconditioning matrix, wherein the preconditioning matrix is configured to cause the components of the plurality of data vectors to be approximately normally distributed.

7. The method of claim 1, further comprising:
generating error correction metadata corresponding to a plurality of bit vectors; and
storing the plurality of bit vectors and the error correction metadata in an index segment of the vector index, the error correction metadata being interleaved with the plurality of bit vectors.

8. The method of claim 7, wherein storing the plurality of bit vectors into the index segment includes packing a plurality of quantized bit values into a byte-aligned bit vector format.

9. The method of claim 7, wherein the index segment is a first index segment, the plurality of bit vectors includes first bit vectors, the method further comprising:
merging the first index segment with a second index segment having second bit vectors, including:
computing a combined representative point for the first index segment and the second index segment;
generating adjusted bit vectors for the first bit vectors and the second bit vectors based on the combined representative point; and
generating quantized bit vectors using the adjusted bit vectors.

10. An apparatus comprising:
a database storing a vector index; and
an index engine including executable instructions that cause at least one processor to:
compute a representative point for at least a plurality of data vectors representing data to be added to the vector index;
generate an adjusted data vector by adjusting a data vector of the plurality of data vectors around the representative point; and
generate a bit vector using the adjusted data vector, including:
determine a quantization interval that reduces a quantization error in a similarity computation; and
map values of the adjusted data vector to components of the bit vector using the quantization interval.

11. The apparatus of claim 10, wherein the executable instructions include instructions that cause the at least one processor to:
determine a first boundary parameter and a second boundary parameter;
execute a comparison of the adjusted data vector with a neighboring vector; and
adjust the first boundary parameter and the second boundary parameter based on the comparison to reduce the quantization error in the similarity computation.

12. The apparatus of claim 10, wherein the representative point is a first representative point, wherein the bit vector is generated using a first quantization process, wherein the executable instructions include instructions that cause the at least one processor to:
generate an adjusted query vector by adjusting a query vector around a second representative point; and
generate a quantized query vector by applying a second quantization process to the adjusted query vector, the second quantization process being different from the first quantization process.

13. The apparatus of claim 12, wherein the executable instructions include instructions that cause the at least one processor to:
estimate a similarity metric between the quantized query vector and the bit vector using a decomposition of a dot product.

14. The apparatus of claim 13, wherein the decomposition includes at least one of:
a query correction term derived from the second representative point and the query vector;
a data correction term derived from the first representative point and the bit vector; and
a quantized residual term derived from a comparison of the quantized query vector and the bit vector.

15. The apparatus of claim 10, wherein the executable instructions include instructions that cause the at least one processor to:
apply an orthogonal transformation to the plurality of data vectors using a preconditioning matrix, wherein the preconditioning matrix is configured to cause the components of the plurality of data vectors to be approximately normally distributed.

16. The apparatus of claim 10, wherein the executable instructions include instructions that cause the at least one processor to:
generate error correction metadata corresponding to a plurality of bit vectors; and
store the plurality of bit vectors and the error correction metadata in an index segment of the vector index, the error correction metadata being interleaved with the plurality of bit vectors.

17. A non-transitory computer readable medium storing executable instructions that cause at least one processor to execute operations, the operations comprising:
computing a representative point for at least a plurality of data vectors representing data to be added to a vector index;
generating an adjusted data vector by adjusting a data vector of the plurality of data vectors around the representative point; and
generating a bit vector using the adjusted data vector, including:
determining a quantization interval that reduces a quantization error in a similarity computation; and
mapping values of the adjusted data vector to components of the bit vector using the quantization interval.

18. The non-transitory computer readable medium of claim 17, wherein the operations further comprise:
determining a first boundary parameter and a second boundary parameter;
executing a comparison of the adjusted data vector with a neighboring vector; and
adjusting the first boundary parameter and the second boundary parameter based on the comparison to reduce the quantization error in the similarity computation.

19. The non-transitory computer readable medium of claim 17, wherein the representative point is a first representative point, wherein the bit vector is generated using a first quantization process, the operations further comprising:
generating an adjusted query vector by adjusting a query vector around a second representative point; and
generating a quantized query vector by applying a second quantization process to the adjusted query vector, the second quantization process being different from the first quantization process.

20. The non-transitory computer readable medium of claim 19, wherein the operations further comprise:
estimating a similarity metric between the quantized query vector and the bit vector using a decomposition of a dot product, wherein the decomposition includes a query correction term derived from the second representative point and the query vector, a data correction term derived from the first representative point and the bit vector, and a quantized residual term derived from a comparison of the quantized query vector and the bit vector.
